(19) United States
(12) Patent Application Publication
(10) Pub. No.: US 2015/0169659 A1
(43) Pub. Date: Jun. 18, 2015

(54) METHOD AND SYSTEM FOR GENERATING USER LIFELOG

(71) Applicant: SAMSUNG ELECTRONICS CO., LTD., Suwon-si (KR)

(72) Inventors: Ho Dong Lee, Yongin-si (KR); Yo Han Roh, Hwaseong-si (KR); Sang Hyun Yoo, Seoul (KR); Ji Hyun Lee, Hwaseong-si (KR); Seok Jin Hong, Hwaseong-si (KR)

(73) Assignee: SAMSUNG ELECTRONICS CO., LTD., Suwon-si (KR)

(21) Appl. No.: 14/534,832

(22) Filed: Nov. 6, 2014

(30) Foreign Application Priority Data
Dec. 13, 2013 (KR) 10-2013-0155618

(51) Int. Cl. G06F 17/30

(52) U.S. Cl. CPC G06F 17/30336; G06F 17/30551; G06F 17/30707

(57) ABSTRACT

A method of generating a user lifelog includes dividing detection data into data units; recognizing a plurality of user activities from arrangements of the data units; generating a plurality of user activity logs by time-sequentially linking the plurality of the recognized user activities; and generating a user lifelog by hierarchically structuring the plurality of user activity logs based on a correlation between the user activity logs.

### CROSS-REFERENCE TO RELATED APPLICATIONS

This application claims the benefit under 35 USC 119(a) of Korean Patent Application No. 10-2013-0155618 filed on Dec. 13, 2013, in the Korean Intellectual Property Office, the entire disclosure of which is incorporated herein by reference for all purposes.

### BACKGROUND

1. Field

The following description relates to technology for recognizing user activities from data acquired by a sensor, analyzing the recognized activities, and generating activity patterns.

2. Description of Related Art

As mobile computing devices and sensor technology develop, technology is being developed for inferring a user's situations or activities from various detection data detected by a sensor in a device carried or worn by a user, and providing user-customized information or services based on the user's inferred activities. However, there are various problems in a method of inferring the user activity patterns from detection data of a mobile computing device.

While detection data may be generated every time the user manipulates a specific function of the mobile computing device, such as a music playing function, if the detection data is generated only by the user, the amount of the generated data might be too small. Thus, there may be a problem of when the mobile computing device would generate the detection data. For example, if the sensors periodically generate the detection data every 10 seconds for 24 hours in a day, the amount of the generated detection data might be excessively large. Moreover, the generated detection data might include worthless and meaningless “noise” data, which cannot be used in actually inferring the user activities. Therefore, to extract only the meaningful detection data from the original detection data, a pre-processing process for standardizing or clustering the detection data according to a predetermined standard may be necessary.

But then there may be another problem, such as what data represents a meaningful user activity in the pre-processed detection data. For example, when inferring comparatively simple user motions, such as sitting, walking, running, or stopping, etc., from the detection data, only the comparatively simple analysis process performable by reviewing the height and velocity of geometrical position data within the detection data is needed. However, inferring the actually meaningful activities to the user, such as jogging, hiking, or fishing, etc., may be difficult to achieve using only the position data or velocity data within the detection data. Particularly, for example, the user is capable of walking or resting while listening to music, and in another example, these user activities may happen in the middle of hiking.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method of generating a user lifelog includes dividing detection data into data units based on a predetermined condition; recognizing a plurality of user activities from arrangements of the data units; generating a plurality of user activity logs by time-sequentially linking the plurality of user activities; and generating a user lifelog by hierarchically structuring the plurality of user activity logs based on a correlation between the user activity logs.

The detection data may be generated periodically at a predetermined interval of time or whenever a predetermined event occurs.

The recognizing of the plurality of user activities may include combining the data units into an arrangement of data units based on a semantic correlation of each of the data units using description logic; comparing the arrangement of data units with a predetermined activity condition; determining whether the arrangement of data units corresponds to the predetermined activity condition based on a result of the comparing; and recognizing the arrangement of data units as an activity corresponding to the predetermined activity condition in response to a result of the determining being that the arrangement of data units corresponds to the predetermined activity condition.

The generating of the plurality of user activity logs may include combining the plurality of user activities into an arrangement thereof based on a semantic correlation of each of the plurality of user activities using description logic; comparing the arrangement of user activities with a predetermined activity log condition; determining whether the arrangement of user activities corresponds to the predetermined activity log condition based on a result of the comparing; and recognizing the arrangement of user activities as an activity log corresponding to the predetermined activity log condition in response to a result of the determining being that the arrangement of user activities corresponds to the predetermined activity log condition.

The generating of the user lifelog may include combining the plurality of user activity logs into an arrangement thereof based on a semantic correlation of each of the plurality of user activity logs using description logic; comparing the arrangement of user activity logs with a predetermined lifelog condition; determining whether the arrangement of user activity logs corresponds to the predetermined lifelog condition based on a result of the comparing; and recognizing the arrangement of user activity logs as a lifelog corresponding to the predetermined lifelog condition in response to a result of the determining being that the arrangement of user activity logs corresponds to the predetermined lifelog condition.

The method may further include processing data included in the user lifelog using a predetermined daily task summary template.

The method may further include generating a natural language summary with respect to the user lifelog using template-based natural language generation technology.

The method may further include adding at least one piece of data among weather information, a call history, and SNS activity information to the user lifelog as journal data; and generating a journal written in a natural language from the journal data.

In another general aspect, a system for generating a user lifelog includes a detector configured to generate detection data; a preprocessor configured to divide the detection data into data units based on a predetermined condition; an activity recognizer configured to recognize a plurality of user activities from arrangements of the data units; an activity log generator configured to generate a plurality of user activity logs by time-sequentially linking the plurality of user activities recognized by the activity recognizer; and a lifelog generator configured to generate a user lifelog by hierarchically structuring the plurality of user activity logs generated by the activity log generator based on a correlation between the plurality of user activity logs.

The detector may be further configured to generate the detection data periodically at a predetermined interval of time or whenever a predetermined event occurs.

The activity recognizer may include an inference engine configured to combine the data units into an arrangement of data units based on a semantic correlation of each of the data units using description logic; compare the arrangement of data units with a predetermined activity condition; determine whether the arrangement of data units corresponds to the predetermined activity condition based on a result of the comparing; and recognize the arrangement of data units as an activity corresponding to the predetermined activity condition in response to a result of the determining being that the arrangement of data units corresponds to the predetermined activity condition.

The activity log generator may include an inference logic configured to combine the plurality of user activities into an arrangement of user activities based on a semantic correlation of each of the plurality of user activities using description logic; compare the arrangement of user activities with a predetermined activity log condition; determine whether the arrangement of user activities corresponds to the predetermined activity log condition based on a result of the comparing; and recognize the arrangement of user activities as an activity log corresponding to the predetermined activity log condition in response to a result of the determining being that the arrangement of user activities corresponds to the predetermined activity log condition.

The lifelog generator may include an inference logic configured to combine the plurality of user activity logs into an arrangement of user activity logs based on a semantic correlation of each of the plurality of user activity logs using description logic; compare the arrangement of user activity logs with a predetermined lifelog condition; determine whether the arrangement of user activity logs corresponds to the predetermined lifelog condition based on a result of the comparing; and recognize the arrangement of user activity logs as a lifelog corresponding to the predetermined lifelog condition in response to a result of the determining being that the arrangement of user activity logs corresponds to the predetermined lifelog condition.

The system may further include a lifelog service provider configured to perform additional processing on the user lifelog generated by the lifelog generator and output the processed user lifelog to a user's mobile computing device.

The lifelog service provider may be further configured to provide any one of or any combination of a service for processing data included in the user lifelog using a predetermined daily task summary template; a service for generating a natural language summary with respect to the user lifelog using template-based natural language generation technology; and a service for adding at least one piece of information among weather information, a call history, and SNS activity information as journal data, and generating a journal written in a natural language using template-based natural language generation technology from the journal data.

In another general aspect, a method of generating a user lifelog includes collecting data about a user's activities; dividing the data into data units; and generating a user lifelog of the user's activities based on arrangements of the data units.

The generating of the user lifelog may include recognizing user activities from the arrangements of the data units based on predetermined activity conditions; recognizing user activity logs from arrangements of the user activities based on predetermined activity log conditions; and generating the user lifelog from the user activity logs based on a correlation between the user activity logs.

The user lifelog may include a plurality of user activity logs arranged in a hierarchical structure based on a correlation between the user activity logs.

The user activity logs may include a user activity log of user activities constituting a user activity in a user activity log higher in the hierarchical structure.

The user activity logs may include a user activity log of user activities occurring during other user activities in a user activity log higher in the hierarchical structure.

In another general aspect, a mobile computing device includes a detector configured to generate data about a user's activities; and a display configured to display a user lifelog of the user's activities generated based on arrangements of data units obtained by dividing the data into the data units.

The user lifelog may be generated by recognizing user activities from the arrangements of the data units based on predetermined activity conditions; recognizing user activity logs from arrangements of the user activities based on predetermined activity log conditions; and generating the user lifelog from the user activity logs based on a correlation between the user activity logs.

The user lifelog may include a plurality of user activity logs arranged in a hierarchical structure based on a correlation between the user activity logs.

The user activity logs may include a user activity log of user activities constituting a user activity in a user activity log higher in the hierarchical structure.

The user activity logs may include a user activity log of user activities occurring during other user activities in a user activity log higher in the hierarchical structure.

Other features and aspects may be apparent from the following detailed description, the drawings, and the claims.

### BRIEF DESCRIPTION OF THE DRAWINGS

FIG. 1 illustrates an example of a method of generating a user lifelog.

FIG. 2 illustrates an example of a system for generating a user lifelog.

FIG. 3 illustrates an example of an activity condition for recognizing activities of a user in a system for generating a lifelog of a user.

FIG. 4 illustrates an example of an activity log including a plurality of time-sequentially linked activities and a lifelog including a plurality of hierarchically structured activity logs in a system for generating a user lifelog.

FIG. 5 illustrates an example of the lifelog of FIG. 4 shown in a spreadsheet form.

FIG. 6 illustrates an example of the lifelog of FIG. 4 marked on a map.

FIG. 7 illustrates an example of a daily task summary template for providing a user with data within the lifelog table of FIG. 5.

FIG. 8A illustrates an example of a display of a user device that displays summary information on each activity using the daily task summary template of FIG. 7.

FIG. 8B illustrates an example of a display of a user device that displays details on each activity of the display illustrated in FIG. 8A.

### DETAILED DESCRIPTION

The following description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

Throughout the drawings and the detailed description, the same reference numerals refer to the same elements. The leftmost digit or digits of a reference numeral identify the figure in which the reference numeral first appears. The drawings may not be to scale, and the relative size, proportions, and depiction of elements in the drawings may be exaggerated for clarity, illustration, and convenience.

A method and system for generating a user lifelog as described below may be implemented by a mobile computing device. The mobile computing device may be any of various devices that the user is capable of carrying or wearing, such as a cellular phone, a smartphone, a smart pad, a smart watch, smart glasses, a tablet, a netbook, and a laptop. The mobile computing device may be equipped with various sensors, such as a camera, a timer, an acceleration sensor, an inertial sensor, an altimeter, and a location tracking device, e.g., a GPS device. These sensors are capable of acquiring various detection data, such as a location and a velocity of the mobile computing device. Thus, these detection data may be used as raw material data for inferring a state of the user carrying the mobile computing device.

Also, the mobile computing device may include a memory and a processor. The memory may store software programs, routines, modules, and/or instructions that implement processes that are capable of analyzing and combining the various detection data acquired from the sensors, and inferring the user's activities. The processor may read and execute the software programs, the routines, the modules, and/or the instructions from the memory, thereby being capable of implementing processes such as data analysis, combination, structuring, and inference.

In describing various examples hereinafter, a component and a sub-component may be mentioned. The component and the sub-component may each represent a function that can be executed by any one or any combination of a processor, a sensor, a software program installed in an application form, and a database or data stored in memory, of the mobile computing device. The component and the sub-component may each be implemented by hardware that includes circuits manufactured to perform specific functions, by software to enable predetermined functions to be performed by a computer processor, or by a combination of the hardware and the software.

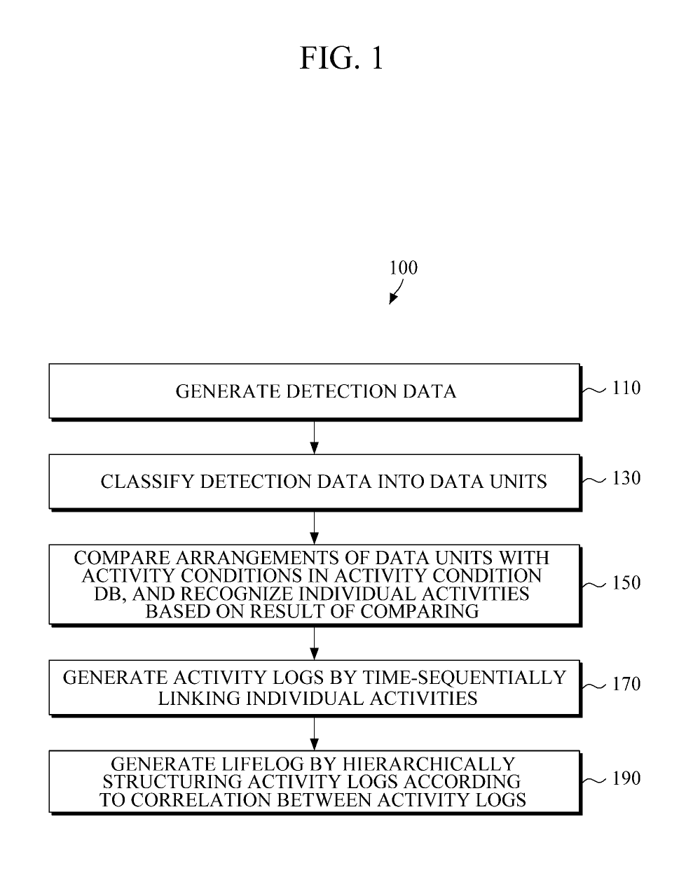

FIG. 1 illustrates an example of a method 100 of generating a user lifelog.

The method 100 of generating a user lifelog may be implemented by a software program or computable-executable instructions by cooperation and execution of all kinds of sensors, memory, and processors included in a mobile computing device, such as a smartphone carried by a user.

Detection data is generated in 110, for example, by sensors in a smartphone or other mobile computing device.

The detection data is classified and/or divided into data units having the same or similar properties at specific time points and locations in 130. Each data unit includes data, such as a user's velocity and altitude, at the specific time points and locations.

The data units are combined into arrangements of data units each including one or more data units by an inference engine according to a semantic correlation of each data unit using description logic. The arrangements of data units are compared with activity conditions stored in an activity condition database (DB) that are set in advance, and individual activities are recognized based on a result of the comparing in 150. The activity conditions may be predetermined and stored in advance by the inference engine according to the semantic correlation of each data unit using description logic.

Activity logs are generated by time-sequentially linking individual activities in 170. In greater detail, recognized activities are combined into arrangements of activities, each of which includes one or more activities, by an inference engine according to the semantic correlation of each activity using description logic. The arrangements of activities are compared with activity log conditions stored in an activity log condition DB that are set in advance, and activity logs are recognized based on a result of the comparing. The activity log conditions may be stored in advance by the inference engine according to the semantic correlation of each activity using description logic.

The recognized activity logs are combined into hierarchically-structured arrangements of activity logs, each of which includes one or more activity logs, by an inference engine according to the semantic correlation of each activity log using the description logic. The arrangements of the activity logs are compared with lifelog conditions stored in a lifelog condition DB that is set in advance, and an individual lifelog is recognized based on a result of the comparing in 190. The lifelog conditions may be stored in advance by the inference engine according to the semantic correlation of each data using the description logic.

The generated lifelog may be additionally processed or be used as basic data for generating other useful information.

In one example, data included in the lifelog may be additionally processed using a preset daily task summary template. Also, a natural language summary may be generated with respect to the lifelog using template-based natural language generation technology. Moreover, at least one piece of data among weather information, a call history, and/or activity information of a social network service (SNS) may be added to the lifelog as journal data. Then, a journal written in the natural language may be generated from the journal data using template-based natural language generation technology.

Furthermore, various services may be provided based on the lifelog. For example, an activity plan table may be automatically generated based on the lifelog during a predetermined period of time. A quantity of activities included in the lifelog may be calculated, and an exercise plan table may be automatically generated based on the calculated quantity during a predetermined period of time. Frequencies of the activities included in the lifelog may be calculated, and recommended activities may be automatically generated during a predetermined period of time based on frequently performed activities. In addition, the activities included in the lifelog may be stored with the associated time and location, and a record of past activities may be generated related to a specific location.

According to the example described above, data related to a dynamic daily life of the user may be obtained by various types of sensors and user input devices and a communication function that are already provided in smart devices, such as a smartphone, a smart pad, and a smart watch. In addition, by using the data, daily activities of the user may be detected and recognized, and a log of structured meaningful information may be generated. Moreover, using the log may generate other useful information, make a daily activity plan for the user, and recommend useful activities for the user.

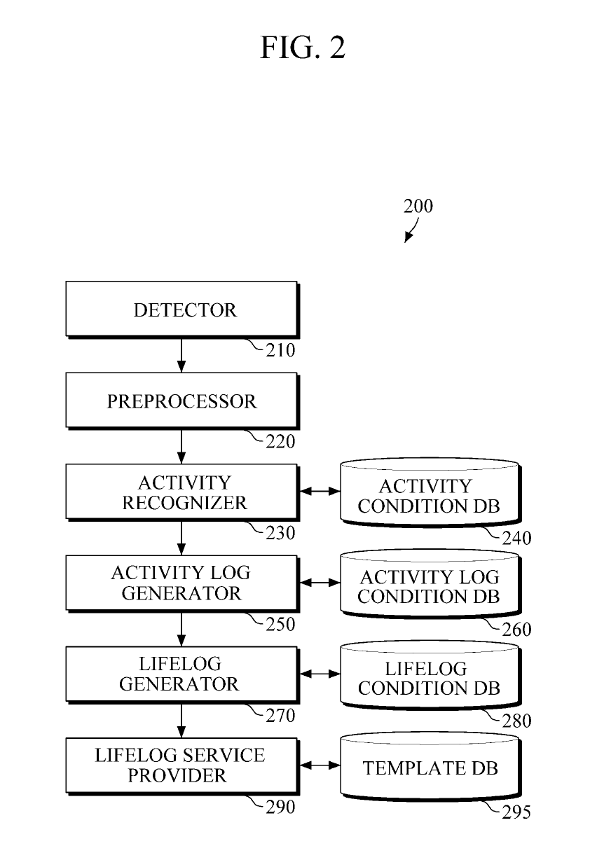

FIG. 2 illustrates an example of a system 200 for generating a user lifelog.

Referring to FIG. 2, the system 200 for generating a user lifelog includes a detector 210, a preprocessor 220, an activity recognizer 230, an activity condition database (DB) 240, an activity log generator 250, an activity log condition database (DB) 260, a lifelog generator 270, a lifelog condition database (DB) 280, a lifelog service provider 290, and a template database (DB) 295, etc.

The detector 210 is a component that generates detection data. The detector 210 may include various hardware sensors. The sensors of the detector 210 may acquire various forms of data, such as a time, a distance, a velocity, a location, a smell, a temperature, a humidity, a sound, an image, a video, a text, and event information, from inside and/or outside of the device equipped with the sensors.

The detector 210 illustrated in FIG. 2 may include subcomponents, such as a sensor (e.g., a GPS sensor), a camera, a microphone, a timer, a smell detector that detects chemicals related to a smell, and an event detector. These subcomponents may include one or more sensor parts, and a processing part that analyzes data acquired from the sensors to generate predetermined detection data.

For example, a location change detector may include an altimeter that senses a height of the sensor, a positioning device using Global Positioning System (GPS) that detects a location with longitude and latitude, map data that indicates where a tracked location is, a timer for calculating a location change according to a lapse of time, i.e., a velocity, and a processing algorithm. The location change detector processes the detection data acquired from the sensors, and consequently generates the detection data that represents the detected location change.

The GPS is a subcomponent for detecting a location. In general, a GPS receiver detects a location after receiving location information with latitude and longitude from a GPS satellite. However, in this example, the GPS may have an additional function for determining a specific location that is detected by reference to map information. For example, the GPS may be associated with map information indicating that the detected location is a specific place, such as a mountain, a river, a road, or a reservoir.

The camera is a subcomponent that generates image data or video data of objects and environments. The camera may include an application to operate itself, and may be operated in association with an image analysis program that analyzes images or videos filmed through the camera, and identifies objects.

The microphone acquires audio data of voices of a user or sounds of surrounding environments. The microphone may be operated not only as hardware but also in association with a function for identifying whether an input sound includes preset information.

The timer may be a clock generator inside a processor, an application that performs a clock function, or any device that can measure time.

The smell detector detects unique smells related to food. For example, the smell detector may detect how concentrations of specific chemicals in the air that are set in advance with regard to specific foods, thereby detecting the smell.

The event detector automatically detects events of a user starting or ending, for example, a specific function for playing music through a touchscreen or input buttons of a mobile computing device. The event detector may detect a user starting and ending a call as events if the mobile computing device has a call function. Also, when a user leaves messages while logged into a social network service (SNS), such as Twitter, through a communication function, e.g., a wireless internet connection function of a mobile computing device, the event detector may automatically detect the SNS activity as an event, and detect information associated with the SNS activity.

Also, the event detector may detect events set by a user. For example, the user may input specific events, or may input instructions for detecting the specific events through the touchscreen or the microphone of the mobile computing device, thereby enabling the event detector to detect the specific events that the user sets.

The subcomponents of the detector 210 described above are merely examples, and the subcomponents of the detector 210 are not limited to these examples. In another example, the detector 210 may further include sensors that detect other data, such as temperature and humidity. Alternatively, the detector 210 may include fewer subcomponents than the examples described above.

The detector 210 may generate detection data periodically at a predetermined time interval. In such a case, the detector 210 may detect all of the detection data or only some of the detection data, such as a location, a velocity, an altitude, a temperature, humidity, a smell, or an image, every one minute or every ten seconds, for example, for 24 hours a day, regardless of a user's intention. The detector 210 may enable the user to control when the detector starts and stops generating the detection data, or may generate the detection data every time an event set in advance is generated. For example, if an event of entering a region set by the user occurs, the generated of the detection data is started, but if the user is out of the region, the generation of the detection data is stopped.

The preprocessor 220 performs preprocessing of noise removal from the detection data generated by the detector 210. Also, the preprocessor 220 analyzes and processes the detection data generated by the detector 210 so that the detection data is divided or classified into data units having a form that can be used by the activity recognizer 230. Each data unit may include data, such as the user's velocity and altitude, at a specific time and location.

The activity recognizer is a component including an inference engine that combines the data units of the detection data provided by the detector 210 and the preprocessor 220, and recognizes the user's activity from the combined data units. The “activity” that the activity recognizer 230 recognizes may be determined by comparing a combination of data units to a activity conditions that are stored in the activity condition DB 240 and set in advance. In other words, the activity recognizer 230 combines the data units into arrangements of data units, each of which includes one or more data units, according to a semantic correlation of each data unit. The arrangements of data units are compared with the activity conditions that are stored in the activity condition DB 240 and set in advance, and an individual activity is recognized based on a result of the comparing.

In such a case, the activity conditions stored in the activity condition DB 240 are defined in advance after one or more data units are combined according to a semantic correlation of each data unit using description logic.

In general, description logic is a tool that is being developed in fields of ontology, the Semantic Web, artificial intelligence, and knowledge engineering. Description logic helps semantic understanding and analysis of a horizontal relation of objects and a hierarchical upper/lower relation of objects using a well-known rule, such as a terminological component (Tbox) and an assertion component (Abox).

In one example, the detection data may include a velocity, an altitude, and a location. A user's activity may be inferred through the combination of the detection data, and may indicate, for example, walking, jogging, and hiking, etc.

As such, the activity condition DB 240 includes activity conditions that define activities, such as walking, jogging, hiking, shopping, driving, riding the subway, fishing, eating a meal, falling down, and a car accident, that are made by combining the detection data that has meanings of a velocity, an altitude, a location, and a motion.

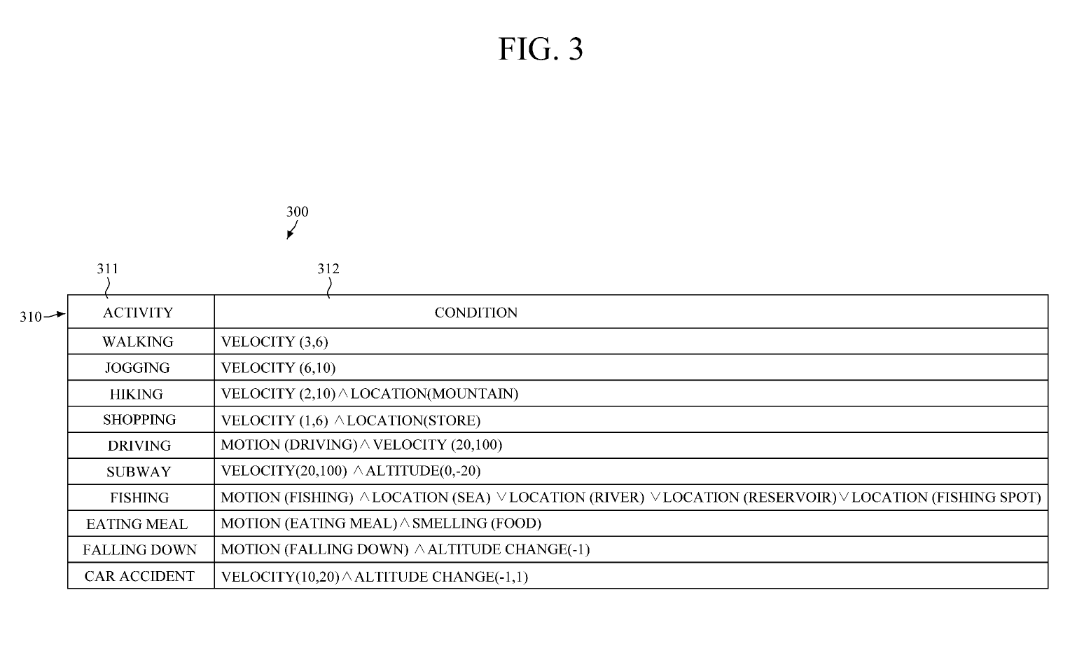

FIG. 3 illustrates an example of an activity condition for recognizing activities of a user in a system for generating a life-log of a user.

Referring to FIG. 3, an example of an activity condition DB 240 is illustrated as a table 300 shown in a form of records 310 including an activity field 311 and a condition field 312.

The activity field 311 includes a user's activities that are set, and as illustrated in FIG. 3, includes walking, jogging, hiking, shopping, driving, riding the subway, fishing, eating a meal, falling down, and a car accident. Those activities are not detectable directly by a specific sensor or a set of sensors. However, those activities may be inferred from data detected by the sensor.

A combination of data units for inferring the activity of the activity field 311 may be set and included in the condition field 312. As illustrated in FIG. 3, data units of velocity (3, 6), of the detection data are listed as a condition corresponding to the walking activity. Velocity (3, 6) may be interpreted to indicate that the user is walking if the velocity falls within a velocity range from a minimum of 3 to a maximum of 6. Next, data units of velocity (6, 10) of the detection data are listed as a condition corresponding to the jogging activity. As a condition corresponding to the hiking activity, velocity (2, 10) and a location (a mountain) are combined with a mark ‘ [symbol] ’, which means “AND”. In FIG. 3, the mark ‘ [symbol] ’ means “OR”.

A combination of data units from the detection data is compared with a combination of one or more data units that are set for each condition, thereby inferring the user's activity. Alternatively, the activity may be recognized by an inference engine from the combination of the data units.

The inference engine is a tool for helping to decide a specific activity through an inference within a predetermined range even if there is no activity exactly corresponding to a raw material, i.e., the arrangement of the data units. The inference engine may be implemented as a software program in general.

Referring to FIG. 2 again, the user's activities recognized by the activity recognizer 230 are generated as an activity log by the activity log generator 250. The activity log may be an activity log of a plurality of time-sequentially linked activities.

The recognized activities are combined into arrangements each including one or more activities according to a semantic correlation of each data by the inference engine of the activity log generator 250 using description logic. The arrangements of activities are compared with activity log conditions stored in an activity log condition DB 260 that is set in advance, individual activity logs are recognized based on a result of the comparing.

In other words, the activity log generator 250 time-sequentially links a plurality of activities according to activity log conditions that are set in advance and stored in the activity log condition DB 260. The activity log conditions stored in the activity log condition DB 260 may be set according to a semantic correlation of each activity using description logic. The operation of time-sequentially linking the plurality of activities may be performed by the inference engine.

The activity log conditions included in the activity log condition DB 260 may be time-sequentially linked among activities recognized by the activity recognizer 230, and may be regulated to include semantically-linked activities in one activity log. For example, an activity ‘hiking’ may be linked to previous activities (e.g., riding the bus or subway) related to an activity of traveling from home to a mountain path entrance. In another example, activities of ‘walking’, ‘resting’, and ‘running’ may be time-sequentially linked activities, which means that a user is moving toward a specific destination. In yet another example, ‘eating refreshments’, ‘eating a meal’, and ‘listening to music’, etc., may be performed together with other different activities at the same time.

The lifelog generator 270 is a component that hierarchically structures a plurality of user activity logs generated by the activity log generator 250 based on a correlation between the user activity logs, thereby generating a user lifelog.

That is, the activity logs are combined into hierarchically-structured arrangements each including one or more activity logs by an inference engine according to a semantic correlation of each activity log using description logic. The arrangements of activity logs are compared with lifelog conditions stored in a lifelog condition DB 280 that are set in advance, and an individual lifelog is recognized based on a result of the comparing.

The lifelog is made after hierarchically structuring the activity logs. For example, if it is assumed that the user performs an activity, such as hiking, the user may walk, run, rest, eat a meal, or listen to music while hiking. As such, the user is capable of doing various activities at the same time. The various activities may have a semantically hierarchical upper/lower relation. Thus, the user activities may be time-sequentially linked according to a horizontal semantic relation between the activities, and also may be hierarchically structured according to a hierarchical semantic relation between the activities.

In one example, a lifelog may generate the activity logs according to lifelog conditions that are predetermined and stored in advance in the lifelog condition DB 280. Also, the lifelog conditions may predetermine a rule for structuring the activity logs according to a hierarchical semantic relation of each of the activity logs using description logic.

The lifelog generator 270 may include an inference engine that generates a lifelog that is structured by comparing activity logs generated by the activity log generator 250 with lifelog conditions stored in advance in the lifelog condition DB 280.

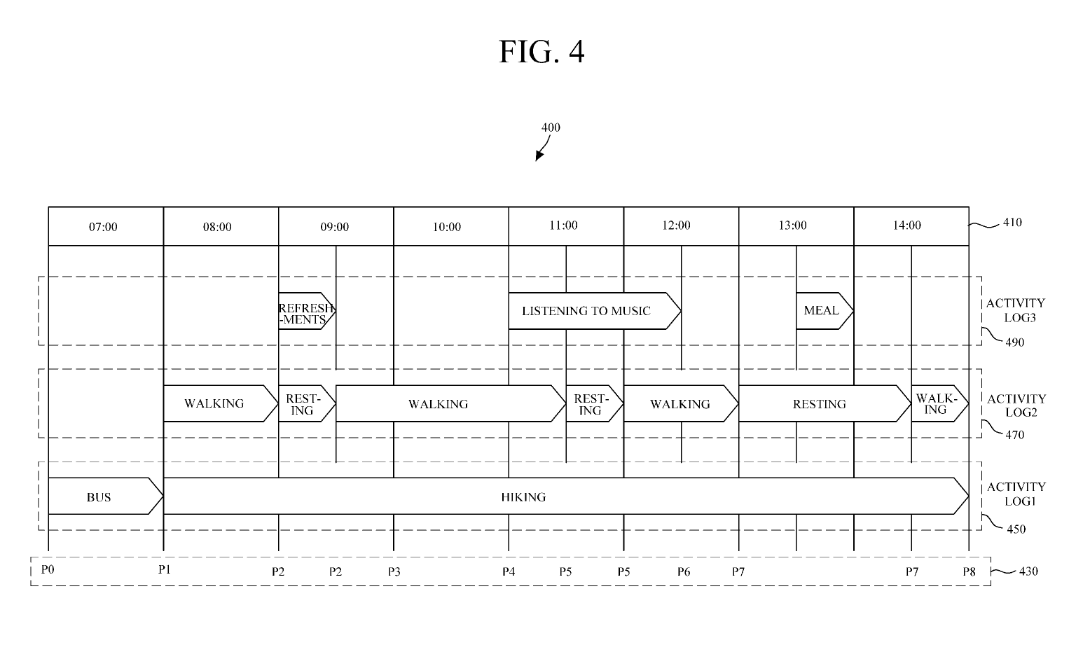

FIGS. 4 to 6 illustrate an example of a lifelog generated by a lifelog generator 270. In this example, the lifelog includes three activity logs, but the lifelog is not limited to this example that includes only those three activity logs. For example, the lifelog may include a fewer than three activity logs or more than three activity logs.

FIG. 4 illustrates an example of an activity log including a plurality of time-sequentially linked activities and a lifelog including a plurality of hierarchically structured activity logs in a system for generating a user lifelog.

Referring to FIG. 4, a lifelog 400 includes three activity logs, i.e., an activity log 1 450, an activity log 2 470, and an activity log 3 490 between a time axis 410 and a location axis 430. The time axis 410 displays a time, and the location axis 430 displays places (locations) where user activities are performed.

The activity log 1 450 is an activity log that includes activities, such as hiking and its linked activity of riding by bus. According to the activity log 1 450, the user moves from a point zero P0 likely to be a bus stop to a point one P1 likely to be a start point of hiking between 07:00 and 08:00. Then, from 08:00 until 15:00, the user hikes, including walking and resting, from the point one P1 to a point eight P8, which, namely, represents the hiking started from the point one P1. The user starts from the point one P1, and arrives at the point two P2 likely to be a mountain temple. The user rests for a while at point two P2, and then passes through a point three P3 and walks to a point four P4 likely to be the highest point of a mountain path. Then, the user rests for a while at point four P4, and then passes through a point five P5 and a point six P6 that are likely to be good scenic points, and walks to a point seven P7 likely to be a popular Buddhist temple. Then, the user has lunch at point seven P7, and then at last arrives at the point eight P8, which is an end point.

In addition, the activity log 2 470 includes activities, such as walking and resting, that are time-sequentially repeated. The activity log 2 470 shows where and when the user walks and rests while hiking. Moreover, the activity log 3 490 shows the time and location of when and where the user has a refreshment or eats a meal, and listens to music while hiking.

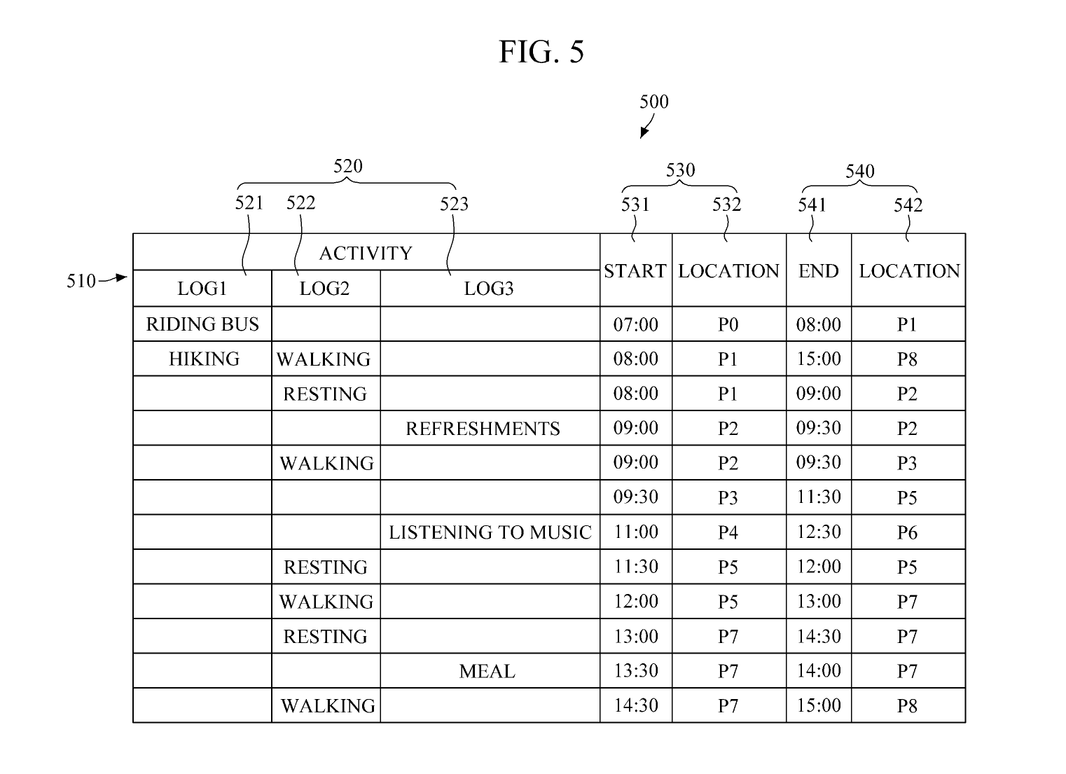

FIG. 5 illustrates an example of the lifelog of FIG. 4 shown in a spreadsheet form. If FIG. 4 is considered to be a diagram for providing an intuitive and easy understanding, a spreadsheet form in FIG. 5 may be considered to be a table form that is made after the detailed data contents illustrated in FIG. 4 are arranged. A lifelog form in FIG. 5 may be a data form for using data of a lifelog for another usage rather than a data form for a user.

Referring to FIG. 5, a lifelog 500 includes a record 510, which includes an activity log field 520, a start point field 530, and an end point field 540 for each activity.

The activity log field 520 includes fields for subordinate activity logs 521, 522, and 523. The activity log 1 521 corresponds to the activity log 1 450 of FIG. 4; the activity log 2 522 corresponds to the activity log 2 470 of FIG. 4; and the activity log 3 523 corresponds to the activity log 3 490 of FIG. 4. The start point field 530 includes a time field 531 that shows a time of the start point, and a location field 532 that shows a location of the start point. The end point field 540 includes a time field 541 that shows a time of the end point, and a location field 542 that shows a location of the end point.

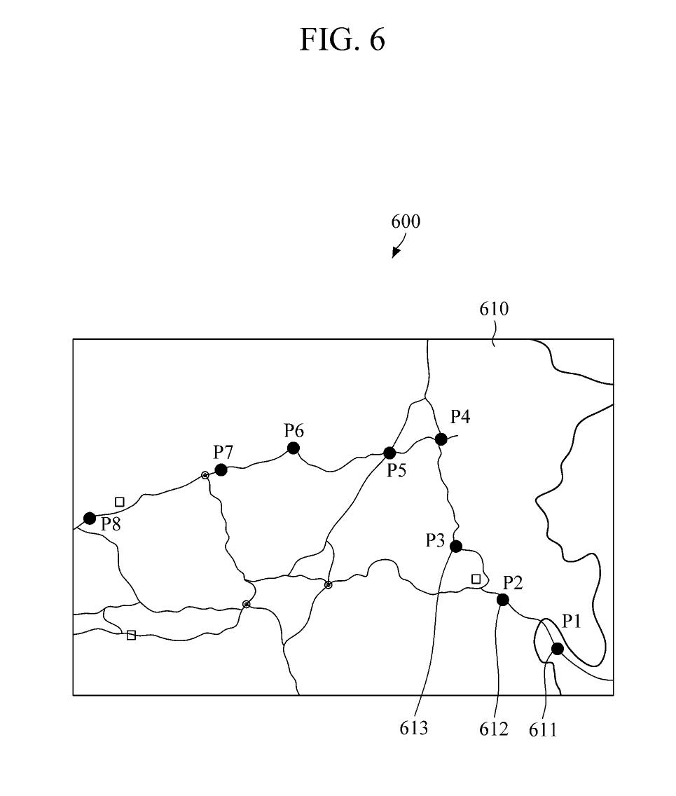

FIG. 6 illustrates an example of the lifelog of FIG. 4 marked on a map.

Referring to FIG. 6, a lifelog 600 includes a plurality of distinct points such as 611, 612, and 613 marked on a map area 610, which is likely to be a map shown on a display of, for example, a smartphone. The lifelog 600 does not display text composed of characters or numbers that represents a specific time or activity, but helps the user obtain an intuitive and easy understanding of the user's hiking path.

As described above, the lifelog, which includes the individual activity logs, may be structured and generated in various manners as illustrated in FIGS. 4 to 6.

Referring to FIG. 2 again, the system 200 for generating a user lifelog includes a lifelog service provider 290 that transforms the generated lifelog to other useful information and provides the transformed lifelog to the user.

The lifelog service provider 290 may additionally process, in various manners, a lifelog generated by a lifelog generator 270 to generate new service information. The generated service information may be output through, for example, a display or a speaker of a mobile computing device of the user, such as a smartphone.

In one example of the additional processing, the lifelog service provider 290 uses a template set in advance and stored in a template DB 295. The template may be a style to display, for example, data of summarized daily tasks on a smartphone display screen of the user in a regular manner.

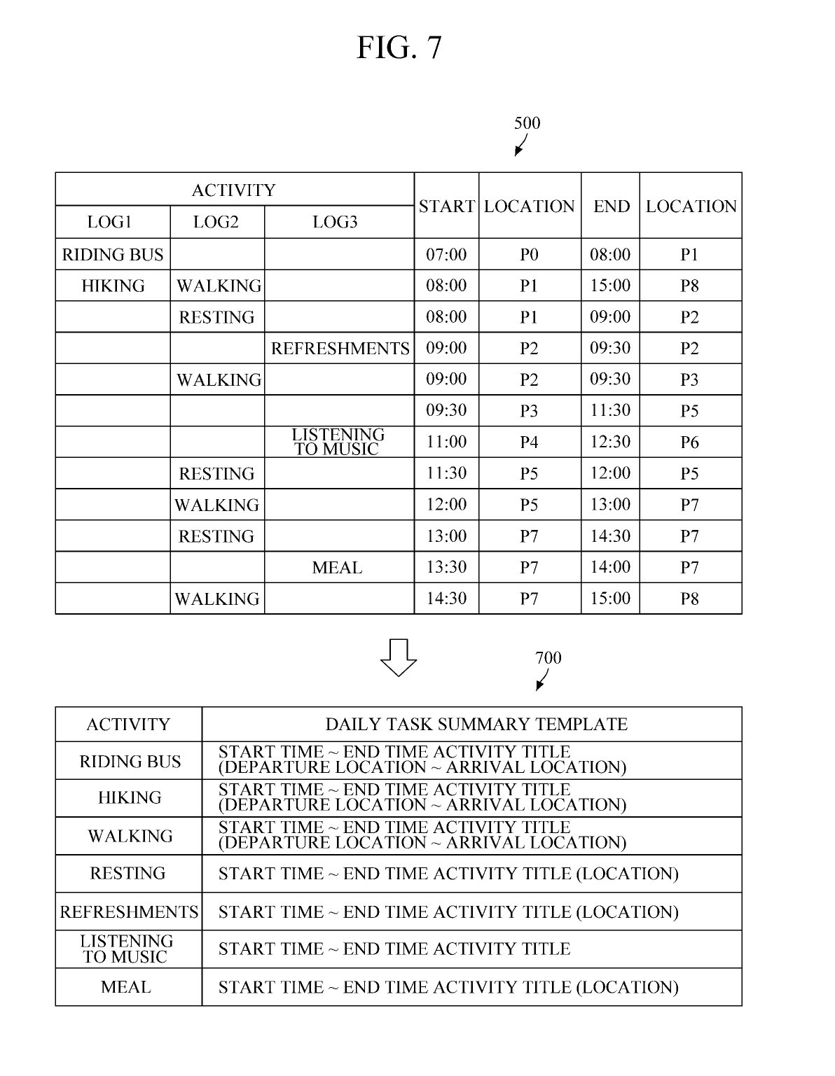

FIG. 7 illustrates an example of a daily task summary template for providing a user with data within the lifelog table of FIG. 5.

Referring to FIG. 7, a daily task summary template 700 defines a start time, an end time, an activity name, a departure location, an arrival location, or a location of each activity included in the lifelog 500 in a predetermined form. For example, as illustrated in FIG. 7, the daily task summary template 700 lists names of the activities according to a lapse of time on the left, and shows a departure time, an arrival time, and a location of each of the activities on the right. The daily task summary template 700 illustrated in FIG. 7 is only one example, and may have various forms as will be apparent to one of ordinary skill in the art.

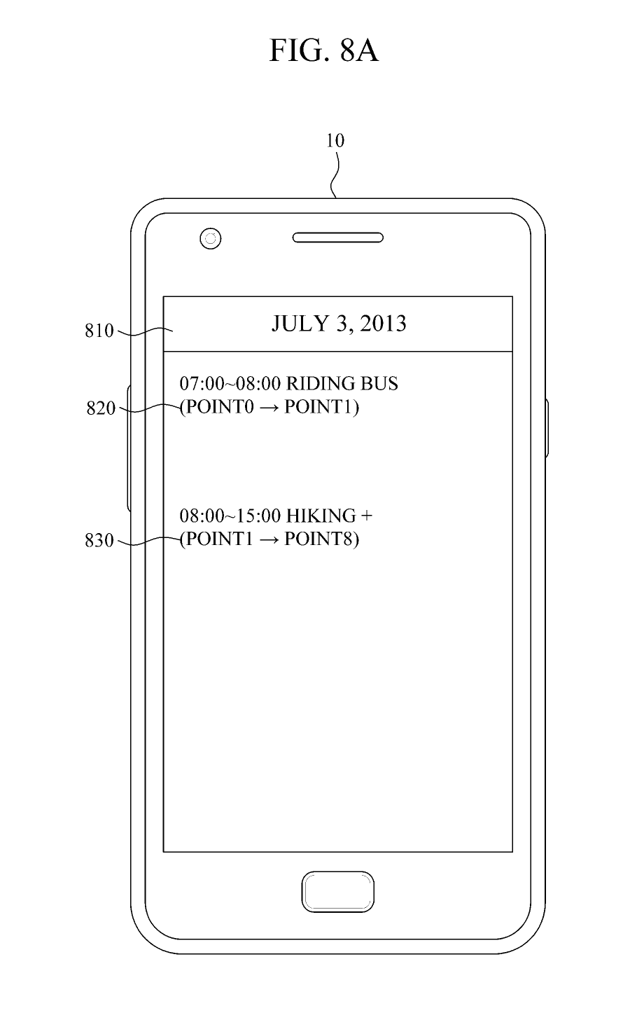

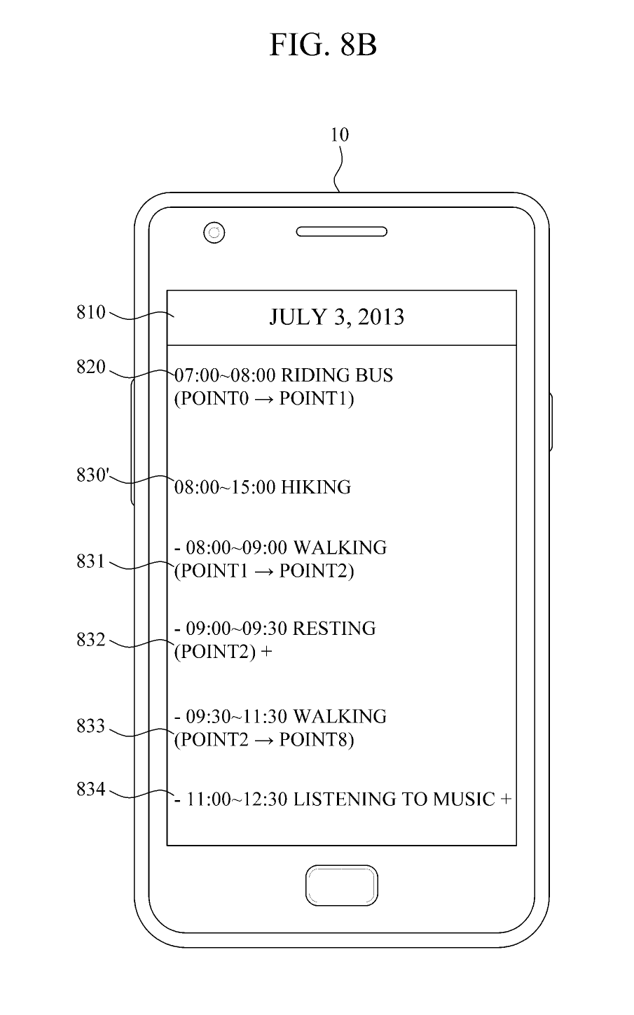

FIG. 8A illustrates an example of a display of a user device that displays summary information for each activity using the daily task summary template of FIG. 7.

FIG. 8B illustrates an example of a display of a user device that displays details for each activity of the display illustrated in FIG. 8A.

Referring to FIGS. 8A and 8B, the summary information for each activity is shown on a screen of a display of a smartphone 10 in a certain form. FIG. 8A shows that the screen displays only a date 810 when activities included in a lifelog were performed, and activities on that day, i.e., a field 820 of riding the bus and a field 830 of hiking, that are included in the activity log 1 521 illustrated in FIG. 5. The field 830 may, through a mark (e.g., ‘+’), notify a user that additional information is available. If the user selects the field 830 (for example, by performing a double tap), other activity logs that are hierarchically lower than the field 830 are displayed on the screen.

FIG. 8B shows that when the user selects the field 830, the screen displays the activities included in both the activity log 2 522 and the activity log 3 523 that are linked with the activity log 1 521 according to hierarchical semantic relations as illustrated in FIG. 5. The field 830′ is shown as being expanded, and includes a field 831 of walking, a field 832 of resting, a field 833 of walking, and a field 834 of listening to music as attached fields. The field 834 also includes the mark ‘+’, which indicates that there is additional information available, as shown in FIG. 8B.

Referring to FIG. 2 again, the lifelog service provider 290 provides a daily task summary service described with reference to FIGS. 7, 8A, and 8B. The daily task information may be generated by the lifelog service provider 290. The lifelog service provider 290 generates the daily task summary information by applying the lifelog to the daily task summary template 700. Then, the daily task summary information is provided to the user's smartphone.

Beyond this, if the data included in the lifelog is additionally processed in various ways, various useful information that is meaningful for the user may be generated.

In one example, the lifelog service provider 290 may provide a service for generating a natural language summary with respect to the lifelog using template-based natural language generation technology. The summary written in a natural language may provide convenience in automatically recording and managing a user's daily activities along with a daily task summary providing a service mentioned above. Such a service may assist in providing medical or assisted living services for the socially disadvantaged, such as disabled or elderly people.

Also, the lifelog service provider 290 may add to the lifelog at least one piece of data among weather information, a call history, and SNS activity information as journal data, and then provide a service for generating a journal written in a template-based natural language from the journal data using natural language generation technology. In such a case, the data added to lifelog, which may include the weather information, the call history, and the SNS activity information, may be easily implemented when a user's mobile device, e.g., a smartphone, has a wireless internet access function.

Moreover, the lifelog service provider 290 may provide a service for automatically making an activity schedule table for a predetermined period of time based on a lifelog. For example, the lifelog service provider 290 may provide a service for making a daily task schedule table, a service for making a weekly task schedule table, and a service for making a monthly task schedule table. Such a service for making a schedule table may be easily performed since there is a lot of stored lifelog data generated for a specific user. Alternatively, even if there is no lifelog regarding the specific user, a schedule table may be made from a lifelog database made by a third person using a lifelog that is generally or specially predicted regarding a person of a general or special type.

Furthermore, the lifelog service provider 290 may provide a service for calculating an amount of workout activities included in the lifelog and automatically making a workout schedule table for a predetermined amount of time based on the calculated workout amount. Such a service may be easily implemented since the lifelog includes activities performed by the user during a daily life, such as walking, running, using stairs, riding a bicycle, or riding the bus.

Also, the lifelog service provider 290 may provide a service for detecting frequencies of activities included in the lifelog and automatically making recommended activities for a predetermined amount of time based on frequently performed activities. In addition, the lifelog service provider 290 may provide a service for saving activities included in the lifelog together with a related time and a location and making a record of activities of the past related to a specific location.

According to the example described above, components of the system 200 for generating a user lifelog may be provided in a mobile computing device carried by a user, such as a smartphone. Alternatively, only the detector 210 of the system 200 may be provided in the user's mobile computing device; and all of the preprocessor 220, the activity recognizer 230, the activity condition DB 240, the activity log generator 250, the activity log condition DB 260, the lifelog generator 270, the lifelog condition DB 280, the lifelog service provider 290, and the template DB 295 may be provided in a remote server system.

In another example, only the lifelog service provider 290 and the template DB 295 of the system 200 may be provided in the remote server system, and the other components in FIG. 2 may be provided in the user's mobile computing device.

The detector 210, the preprocessor 220, the activity recognizer 230, the activity condition DB 240, the activity log generator 250, the activity log condition DB 260, the lifelog generator 270, the lifelog condition DB 280, the lifelog service provider 290, and the template DB 295 in FIG. 2 that perform the various operations described with respect to FIGS. 1-8B may be implemented using one or more hardware components, one or more software components, or a combination of one or more hardware components and one or more software components.

A hardware component may be, for example, a physical device that physically performs one or more operations, but is not limited thereto. Examples of hardware components include resistors, capacitors, inductors, power supplies, frequency generators, operational amplifiers, power amplifiers, low-pass filters, high-pass filters, band-pass filters, analog-to-digital converters, digital-to-analog converters, and processing devices.

A software component may be implemented, for example, by a processing device controlled by software or instructions to perform one or more operations, but is not limited thereto. A computer, controller, or other control device may cause the processing device to run the software or execute the instructions. One software component may be implemented by one processing device, or two or more software components may be implemented by one processing device, or one software component may be implemented by two or more processing devices, or two or more software components may be implemented by two or more processing devices.

A processing device may be implemented using one or more general-purpose or special-purpose computers, such as, for example, a processor, a controller and an arithmetic logic unit, a digital signal processor, a microcomputer, a field-programmable array, a programmable logic unit, a microprocessor, or any other device capable of running software or executing instructions. The processing device may run an operating system (OS), and may run one or more software applications that operate under the OS. The processing device may access, store, manipulate, process, and create data when running the software or executing the instructions. For simplicity, the singular term “processing device” may be used in the description, but one of ordinary skill in the art will appreciate that a processing device may include multiple processing elements and multiple types of processing elements. For example, a processing device may include one or more processors, or one or more processors and one or more controllers. In addition, different processing configurations are possible, such as parallel processors or multi-core processors.

A processing device configured to implement a software component to perform an operation A may include a processor programmed to run software or execute instructions to control the processor to perform operation A. In addition, a processing device configured to implement a software component to perform an operation A, an operation B, and an operation C may have various configurations, such as, for example, a processor configured to implement a software component to perform operations A, B, and C; a first processor configured to implement a software component to perform operation A, and a second processor configured to implement a software component to perform operations B and C; a first processor configured to implement a software component to perform operations A and B, and a second processor configured to implement a software component to perform operation C; a first processor configured to implement a software component to perform operation A, a second processor configured to implement a software component to perform operation B, and a third processor configured to implement a software component to perform operation C; a first processor configured to implement a software component to perform operations A, B, and C, and a second processor configured to implement a software component to perform operations A, B, and C, or any other configuration of one or more processors each implementing one or more of operations A, B, and C. Although these examples refer to three operations A, B, C, the number of operations that may implemented is not limited to three, but may be any number of operations required to achieve a desired result or perform a desired task.

Software or instructions for controlling a processing device to implement a software component may include a computer program, a piece of code, an instruction, or some combination thereof, for independently or collectively instructing or configuring the processing device to perform one or more desired operations. The software or instructions may include machine code that may be directly executed by the processing device, such as machine code produced by a compiler, and/or higher-level code that may be executed by the processing device using an interpreter. The software or instructions and any associated data, data files, and data structures may be embodied permanently or temporarily in any type of machine, component, physical or virtual equipment, computer storage medium or device, or a propagated signal wave capable of providing instructions or data to or being interpreted by the processing device. The software or instructions and any associated data, data files, and data structures also may be distributed over network-coupled computer systems so that the software or instructions and any associated data, data files, and data structures are stored and executed in a distributed fashion.

For example, the software or instructions and any associated data, data files, and data structures may be recorded, stored, or fixed in one or more non-transitory computer-readable storage media. A non-transitory computer-readable storage medium may be any data storage device that is capable of storing the software or instructions and any associated data, data files, and data structures so that they can be read by a computer system or processing device. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, or any other non-transitory computer-readable storage medium known to one of ordinary skill in the art.

Functional programs, codes, and code segments for implementing the examples disclosed herein can be easily constructed by a programmer skilled in the art to which the examples pertain based on the drawings and their corresponding descriptions as provided herein.

While this disclosure includes specific examples, it will be apparent to one of ordinary skill in the art that various changes in form and details may be made in these examples without departing from the spirit and scope of the claims and their equivalents. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A method of generating a user lifelog, the method comprising:
dividing detection data into data units based on a predetermined condition;
recognizing a plurality of user activities from arrangements of the data units;
generating a plurality of user activity logs by time-sequentially linking the plurality of user activities; and
generating a user lifelog by hierarchically structuring the plurality of user activity logs based on a correlation between the user activity logs.

2. The method of claim 1, wherein the detection data is generated periodically at a predetermined interval of time or whenever a predetermined event occurs.

3. The method of claim 1, wherein the recognizing of the plurality of user activities comprises:
combining the data units into an arrangement of data units based on a semantic correlation of each of the data units using description logic;
comparing the arrangement of data units with a predetermined activity condition;
determining whether the arrangement of data units corresponds to the predetermined activity condition based on a result of the comparing; and
recognizing the arrangement of data units as an activity corresponding to the predetermined activity condition in response to a result of the determining being that the arrangement of data units corresponds to the predetermined activity condition.

4. The method of claim 1, the generating of the plurality of user activity logs comprises:
combining the plurality of user activities into an arrangement thereof based on a semantic correlation of each of the plurality of user activities using description logic;
comparing the arrangement of user activities with a predetermined activity log condition;
determining whether the arrangement of user activities corresponds to the predetermined activity log condition based on a result of the comparing; and
recognizing the arrangement of user activities as an activity log corresponding to the predetermined activity log condition in response to a result of the determining being that the arrangement of user activities corresponds to the predetermined activity log condition.

5. The method of claim 1, wherein the generating of the user lifelog comprises:
combining the plurality of user activity logs into an arrangement thereof based on a semantic correlation of each of the plurality of user activity logs using description logic;
comparing the arrangement of user activity logs with a predetermined lifelog condition;
determining whether the arrangement of user activity logs corresponds to the predetermined lifelog condition based on a result of the comparing; and
recognizing the arrangement of user activity logs as a lifelog corresponding to the predetermined lifelog condition in response to a result of the determining being that the arrangement of user activity logs corresponds to the predetermined lifelog condition.

6. The method of claim 1, further comprising processing data included in the user lifelog using a predetermined daily task summary template.

7. The method of claim 1, further comprising generating a natural language summary with respect to the user lifelog using template-based natural language generation technology.

8. The method of claim 1, further comprising:
adding at least one piece of data among weather information, a call history, and SNS activity information to the user lifelog as journal data; and
generating a journal written in a natural language from the journal data.

9. A system for generating a user lifelog, the system comprising:
a detector configured to generate detection data;
a preprocessor configured to divide the detection data into data units based on a predetermined condition;
an activity recognizer configured to recognize a plurality of user activities from arrangements of the data units;
an activity log generator configured to generate a plurality of user activity logs by time-sequentially linking the plurality of user activities recognized by the activity recognizer; and
a lifelog generator configured to generate a user lifelog by hierarchically structuring the plurality of user activity logs generated by the activity log generator based on a correlation between the plurality of user activity logs.

10. The system of claim 9, wherein the detector is further configured to generate the detection data periodically at a predetermined interval of time or whenever a predetermined event occurs.

11. The system of claim 9, wherein the activity recognizer comprises an inference engine configured to:
combine the data units into an arrangement of data units based on a semantic correlation of each of the data units using description logic;
compare the arrangement of data units with a predetermined activity condition;
determine whether the arrangement of data units corresponds to the predetermined activity condition based on a result of the comparing; and
recognize the arrangement of data units as an activity corresponding to the predetermined activity condition in response to a result of the determining being that the arrangement of data units corresponds to the predetermined activity condition.

12. The system of claim 9, wherein the activity log generator comprises an inference logic configured to:
combine the plurality of user activities into an arrangement of user activities based on a semantic correlation of each of the plurality of user activities using description logic;
compare the arrangement of user activities with a predetermined activity log condition;
determine whether the arrangement of user activities corresponds to the predetermined activity log condition based on a result of the comparing; and
recognize the arrangement of user activities as an activity log corresponding to the predetermined activity log condition in response to a result of the determining being that the arrangement of user activities corresponds to the predetermined activity log condition.

13. The system of claim 9, wherein the lifelog generator comprises an inference logic configured to:
combine the plurality of user activity logs into an arrangement of user activity logs based on a semantic correlation of each of the plurality of user activity logs using description logic;
compare the arrangement of user activity logs with a predetermined lifelog condition;
determine whether the arrangement of user activity logs corresponds to the predetermined lifelog condition based on a result of the comparing; and
recognize the arrangement of user activity logs as a lifelog corresponding to the predetermined lifelog condition in response to a result of the determining being that the arrangement of user activity logs corresponds to the predetermined lifelog condition.

14. The system of claim 9, further comprising a lifelog service provider configured to perform additional processing on the user lifelog generated by the lifelog generator and output the processed user lifelog to a user's mobile computing device.

15. The system of claim 14, wherein the lifelog service provider is further configured to provide any one of or any combination of:
a service for processing data included in the user lifelog using a predetermined daily task summary template;
a service for generating a natural language summary with respect to the user lifelog using template-based natural language generation technology; and
a service for adding at least one piece of information among weather information, a call history, and SNS activity information as journal data, and generating a journal written in a natural language using template-based natural language generation technology from the journal data.

16. A method of generating a user lifelog, the method comprising:
collecting data about a user's activities;
dividing the data into data units; and
generating a user lifelog of the user's activities based on arrangements of the data units.

17. The method of claim 16, wherein the generating of the user lifelog comprises:
recognizing user activities from the arrangements of the data units based on predetermined activity conditions;
recognizing user activity logs from arrangements of the user activities based on predetermined activity log conditions; and
generating the user lifelog from the user activity logs based on a correlation between the user activity logs.

18. The method of claim 16, wherein the user lifelog comprises a plurality of user activity logs arranged in a hierarchical structure based on a correlation between the user activity logs.

19. The method of claim 18, wherein the user activity logs comprise a user activity log of user activities constituting a user activity in a user activity log higher in the hierarchical structure.

20. The method of claim 18, wherein the user activity logs comprise a user activity log of user activities occurring during other user activities in a user activity log higher in the hierarchical structure.

21. A mobile computing device comprising:
a detector configured to generate data about a user's activities; and
a display configured to display a user lifelog of the user's activities generated based on arrangements of data units obtained by dividing the data into the data units.

22. The mobile computing device of claim 21, wherein the user lifelog is generated by:
recognizing user activities from the arrangements of the data units based on predetermined activity conditions;
recognizing user activity logs from arrangements of the user activities based on predetermined activity log conditions; and
generating the user lifelog from the user activity logs based on a correlation between the user activity logs.

23. The mobile computing device of claim 21, wherein the user lifelog comprises a plurality of user activity logs arranged in a hierarchical structure based on a correlation between the user activity logs.

24. The mobile computing device of claim 23, wherein the user activity logs comprise a user activity log of user activities constituting a user activity in a user activity log higher in the hierarchical structure.

25. The mobile computing device of claim 23, wherein the user activity logs comprise a user activity log of user activities occurring during other user activities in a user activity log higher in the hierarchical structure.
